(19) United States
(12) Patent Application Publication
(10) Pub. No.: US 2018/0170702 A1
(43) Pub. Date: Jun. 21, 2018

(54) SHEET MATERIAL CONVEYING DEVICE

(71) Applicant: HONDA MOTOR CO., LTD., Tokyo (JP)

(72) Inventors: Yusuke Wada, Wako-shi (JP); Kensuke Namba, Wako-shi (JP)

(21) Appl. No.: 15/841,478

(22) Filed: Dec. 14, 2017

(30) Foreign Application Priority Data
Dec. 19, 2016 (JP) 2016-245513

(51) Int. Cl. B65H 35/00; B65H 16/10; B65H 20/10; B65H 35/08; B65H 35/02; B65H 41/00; H01M 8/1004; H01M 8/1018

(52) U.S. Cl. CPC B65H 35/008; H01M 2008/1095; B65H 20/10; B65H 35/006; B65H 35/08; B65H 35/02; B65H 41/00; H01M 8/1004; H01M 8/1018; B65H 2301/415185; B65H 2301/44324; B65H 2301/51512; B65H 2301/515323; B65H 2301/5155; B65H 2406/351; B65H 2801/72; H01M 2250/20; B65H 16/106

(57) ABSTRACT

A sheet material conveying device unwinds from a roll body a sheet-shaped member constituting a membrane electrode assembly and conveys the sheet-shaped member. The sheet material conveying device is equipped with a suction member that moves the sheet-shaped member, and a negative pressure supply unit that supplies a negative pressure to the suction member. The suction member is constituted by a porous body capable of sucking under the negative pressure one surface of the sheet material having been unwound from the roll body and is movable in a conveying direction.

### CROSS-REFERENCE TO RELATED APPLICATION

This application is based upon and claims the benefit of priority from Japanese Patent Application No. 2016-245513 filed on Dec. 19, 2016, the contents of which are incorporated herein by reference.

### BACKGROUND OF THE INVENTION

### Field of the Invention

The present invention relates to a sheet material conveying device for unwinding from a roll body and conveying a sheet-shaped member that constitutes a membrane electrode assembly of a fuel cell.

### Description of the Related Art

Generally, a solid polymer electrolyte fuel cell employs a solid polymer electrolyte membrane constituted by a polymer ion exchange membrane. The fuel cell is equipped with a membrane electrode assembly (MEA) wherein an anode and a cathode are arranged respectively on one surface and the other surface of the solid polymer electrolyte membrane.

The membrane electrode assembly constitutes a power generation cell (unit fuel cell) by being held and sandwiched by separators (bipolar plates). A predetermined number of such power generation cells are stacked to be used as, for example, a vehicle-mounted fuel cell stack.

In a manufacturing process for a membrane electrode assembly, a sheet-shaped member (electrode catalyst layer sheet, for example) constituting the membrane electrode assembly for example is unwound from a roll body which is configured by the sheet-shaped member wound, and the member having been unwound is cut to a desired product dimension. In this case, for conveying the sheet-shaped member having been unwound from the roll body, it has heretofore been conventional to use nip rolls (refer to Japanese Laid-Open Patent Publication No. 2016-091997).

### SUMMARY OF THE INVENTION

However, in conveyance using the nip rolls, outer surfaces of the nip rolls contact both surfaces of the sheet-shaped member, and the sheet-shaped member is pressurized. Thus, there arises a problem that contaminants are mixed with the sheet-shaped member (product).

The present invention has been made with the aforementioned problem taken into consideration, and it is an object of the present invention to provide a sheet material conveying device capable of reducing contaminants mixed with a sheet-shaped member during conveyance.

In order to accomplish the aforementioned object, a feature of the present invention resides in a sheet material conveying device for unwinding and conveying a sheet-shaped member constituting a membrane electrode assembly from a roll body which is configured by the sheet-shaped member wound in the form of a roll, wherein the apparatus comprises a suction member configured by a porous body that sucks under a negative pressure one surface of the sheet-shaped member having been unwound from the roll body and draws the sheet-shaped member in a conveying direction, and a negative pressure supply unit that supplies the negative pressure to the suction member.

Preferably, the one surface of the sheet-shaped member which surface is drawn by the suction member is a lower surface of the sheet-shaped member during conveyance.

Preferably, the suction member is made of ceramic.

Preferably, the suction member is reciprocatively movable between a first position on an upstream side and a second position on a downstream side set along the conveying direction and is capable of moving the sheet-shaped member by a predetermined length at a time in the conveying direction.

Preferably, the aforementioned sheet material conveying device is equipped with a cutting mechanism that cuts the sheet-shaped member having been unwound from the roll body, and at least one portion of the cutting mechanism cuts the sheet-shaped member while the sheet-shaped member is being moved by the suction member.

Preferably, the sheet-shaped member is belt-shaped, and the cutting mechanism has a first cutting unit constituting the at least one portion that cuts the sheet-shaped member along a longitudinal direction of the sheet-shaped member, and a second cutting unit that cuts the sheet-shaped member along a width direction of the sheet-shaped member.

Preferably, the first cutting unit is disposed on an upstream side in the conveying direction relative to the suction member, while the second cutting unit is disposed on a downstream side in the conveying direction relative to the suction member.

Preferably, the second cutting unit refrains from cutting the sheet-shaped member while the first cutting unit is cutting the sheet-shaped member.

Preferably, the cutting mechanism has rotary cutters each made of ceramic.

Preferably, the first cutting unit has first rotary cutters, and the second cutting unit has a second rotary cutter movable in a width direction of the sheet-shaped member.

According to the present invention, the sheet material conveying device comprises the suction member configured by the porous body that sucks under a negative pressure one surface of the sheet-shaped member having been unwound from the roll body and draws the sheet-shaped member in the conveying direction, and the negative pressure supply unit that supplies the negative pressure to the suction member. Thus, unlike the conveyance by nip rolls, it is possible to convey the sheet-shaped member while avoiding contacts and pressurizations on both surfaces of the sheet-shaped member. Accordingly, it can be realized to reduce or suppress contaminants mixed with the sheet-shaped member.

The above and other objects, features and advantages of the present invention will become more apparent from the following description when taken in conjunction with the accompanying drawings, in which a preferred embodiment of the present invention is shown by way of an illustrative example.

### BRIEF DESCRIPTION OF THE DRAWINGS

FIG. 1 is a perspective view of a sheet material conveying device according to an embodiment of the present invention;

FIG. 2 is a schematic side view of the sheet material conveying device;

FIG. 3 is a first explanatory view for explaining the operation of the sheet material conveying device;

FIG. 4 is a second explanatory view for explaining the operation of the sheet material conveying device; and

FIG. 5 is a third explanatory view for explaining the operation of the sheet material conveying device.

### DESCRIPTION OF THE PREFERRED EMBODIMENTS

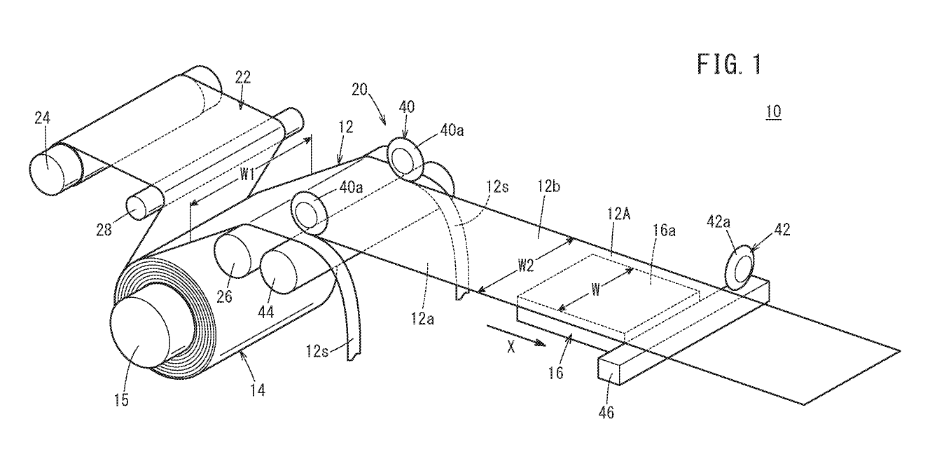

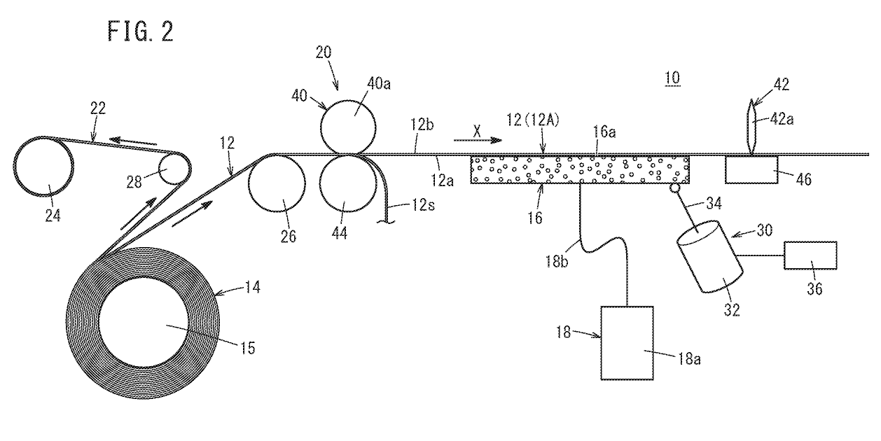

A sheet material conveying device 10 according to an embodiment of the present invention shown in FIGS. 1 and 2 is an apparatus for unwinding and conveying a sheet-shaped member 12 constituting a membrane electrode assembly (MEA) from a roll body 14 which is configured by the sheet-shaped member 12 wound in the form of a roll.

The membrane electrode assembly is a fuel cell component which constitutes a fuel cell (power generation cell) together with separators. The fuel cell is equipped with the membrane electrode assembly and the separators respectively arranged on both surfaces of the membrane electrode assembly, and a plurality of fuel cells are stacked to configure a fuel cell stack. The fuel cell stack is mounted on, for example, a fuel cell electric vehicle (not shown) as a vehicle-mounted fuel cell stack.

The membrane electrode assembly has an electrolyte membrane and electrodes (an anode and a cathode) provided on both surfaces of the electrolyte membrane. The electrolyte membrane is, for example, a solid polymer electrolyte membrane (cation exchange membrane). The solid polymer electrolyte membrane is, for example, a thin film of perfluorosulfonic acid containing water. Each electrode is made of, for example, catalyst-coated diffusion media (CCDM) having an electrode catalyst layer and a gas diffusion layer.

The sheet-shaped member 12 is a member constituting at least a part of layers forming the membrane electrode assembly and is, for example, the CCDM. Besides, the sheet-shaped member 12 may be catalyst-coated media (CCM), a carbon paper, a member formed with an intermediate layer including carbon in a carbon paper, an electrolyte membrane or a membrane electrode assembly itself.

As shown in FIGS. 1 and 2, the sheet material conveying device 10 is equipped with an unwinding shaft 15 rotatably supporting the roll body 14, a suction member 16 that sucks and draws the sheet-shaped member 12 having been unwound from the roll body 14 in a conveying direction (the direction of the arrow X), a negative pressure supply unit 18 (refer to FIG. 2) that supplies a negative pressure to the suction member 16, and a cutting mechanism 20 that cuts the sheet-shaped member 12 having been unwound from the roll body 14.

The roll body 14 is mounted on the unwinding shaft 15. In the roll body 14, the belt-like sheet-shaped member 12 and an interlayer film 22 are wound in the form of a roll with one put on the other. Therefore, the sheet-shaped member 12 is wound into the roll body 14 with its both surfaces out of direct contact with each other. The interlayer film 22 is also unwound together with the unwinding of the sheet-shaped member 12 from the roll body 14. The unwound interlayer film 22 is wound by a winding roll 24.

The sheet-shaped member 12 having been unwound from the roll body 14 and having been separated from the interlayer film 22 is guided by an intermediate guide roll 26 disposed between the roll body 14 and the suction member 16. The interlayer film 22 having been unwound from the roll body 14 and having been separated from the sheet-shaped member 12 is guided by an intermediate guide roll 28 disposed between the roll body 14 and the winding roll 24.

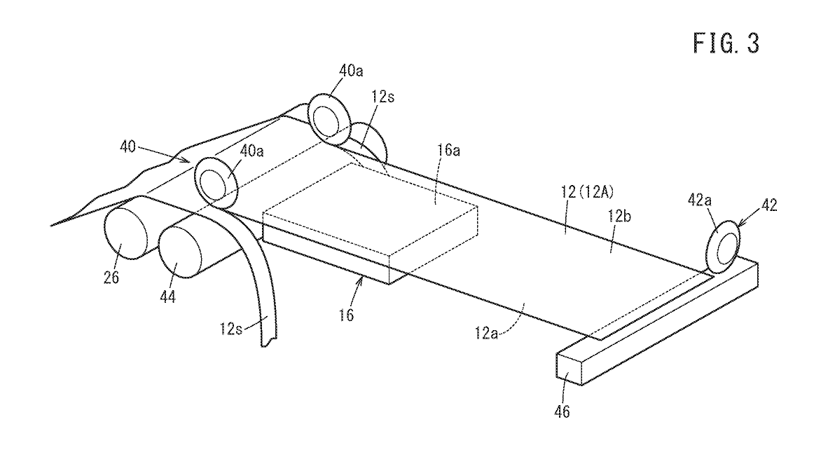

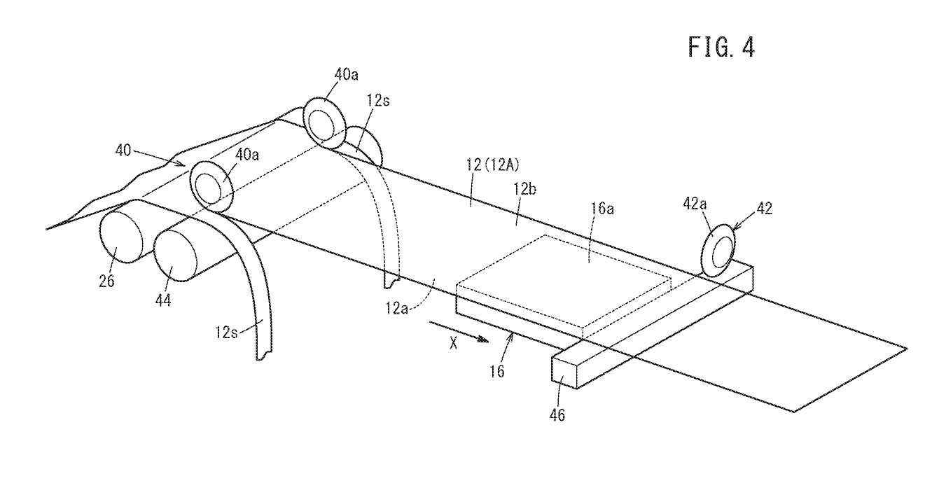

The suction member 16 is constituted by a porous body which is capable of sucking one surface (lower surface 12a) of the sheet-shaped member 12 having been unwound from the roll body 14, and draws the sheet-shaped member 12 in the conveying direction by suction. The suction member 16 is made of ceramic (made of zirconia, alumina, silicon carbide or the like, for example). The suction member 16 is reciprocatively movable between a first position (refer to FIG. 3) on an upstream side and a second position (refer to FIG. 4) on a downstream side set along the conveying direction and moves the sheet-shaped member 12 by a predetermined length at a time in the conveying direction.

In the present embodiment, the suction member 16 takes the form of an air suction board configured in a plate shape. As shown in FIG. 1, a width dimension W of the suction member 16 is narrower than a width dimension W2 (product width dimension) of the sheet-shaped member 12 whose opposite end portions in the width direction have been cut (hereafter written as “sheet-shaped member 12A”). Incidentally, the width dimension W of the suction member 16 may be equal to or wider than the width dimension W2 of the sheet-shaped member 12A.

As shown in FIG. 2, the sheet material conveying device 10 is equipped with a drive mechanism 30 that operates the suction member 16. The sheet material conveying device 10 is equipped with a guide mechanism though not shown, and the guide mechanism guides the movement of the suction member 16. The drive mechanism 30 has an actuator 32 such as a servomotor or the like, and the driving power of the actuator 32 is transmitted to the suction member 16 through a suitable driving power transmission mechanism 34, so that the suction member 16 is moved in the conveying direction (the direction of the arrow X) and in an opposite direction to the conveying direction. The operation of the actuator 32 is controlled by a control unit 36 of the sheet material conveying device 10. Incidentally, the suction member 16 may be driven directly by using a linear motor or an air cylinder as the actuator 32.

The negative pressure supply unit 18 has a suction pump 18a that generates a negative pressure. The suction pump 18a is connected to the suction member 16 through, for example, a flexible tube 18b. Thus, it is possible to perform the movement of the suction member 16 without hindrance and to supply the negative pressure to the suction member 16 satisfactorily.

The cutting mechanism 20 has a first cutting unit 40 that cuts the sheet-shaped member 12 along a longitudinal direction of the sheet-shaped member 12 and a second cutting unit 42 that cuts the sheet-shaped member 12 along a width direction of the sheet-shaped member 12. The first cutting unit 40 is disposed on an upstream side in the conveying direction relative to the suction member 16 and on a downstream side in the conveying direction relative to the intermediate guide roll 26. The second cutting unit 42 is disposed on a downstream side in the conveying direction relative to the suction member 16.

As shown in FIG. 1, the first cutting unit 40 has two disc-shaped first rotary cutters 40a and makes cuts (slits) at the opposite end portions in the width direction of the sheet-shaped member 12 along the longitudinal direction of the sheet-shaped member 12, so that the sheet-shaped member 12 is cut to the product width dimension. The two first rotary cutters 40a are arranged with a space in the width direction of the sheet-shaped member 12 and are configured to be rotatable about an axis parallel to the width direction of the sheet-shaped member 12. The two first rotary cutters 40a are each made of a material which does not include any metal ingredient (particularly, iron content), and are each made of ceramic (made of zirconia, alumina, silicon carbide or the like, for example).

A pedestal roll 44 is disposed under the two first rotary cutters 40a. The pedestal roll 44 is larger (longer) than the width dimension W1 of the sheet-shaped member 12 being in an initial state (the state before being cut by the first cutting unit 40). The pedestal roll 44 is made of ceramic (made of zirconia, for example). With the sheet-shaped member 12 put between the two first rotary cutters 40a and the pedestal roll 44, the sheet-shaped member 12 is conveyed in the conveying direction, whereby the opposite end portions in the width direction of the sheet-shaped member 12 are cut by the two first rotary cutters 40a.

The second cutting unit 42 has a disc-shaped second rotary cutter 42a and cuts by the second rotary cutter 42a the length in the longitudinal or lengthwise direction of the sheet-shaped member 12 (the sheet-shaped member 12A having been cut to the product width dimension) to a product dimension. The second rotary cutter 42a is rotatable about an axis parallel to the conveying direction of the sheet-shaped member 12 and is movable in the width direction of the sheet-shaped member 12. The second rotary cutter 42a is made of a material which does not include any metal ingredient (particularly, iron content), and is made of ceramic (made of zirconia, alumina, silicon carbide or the like, for example).

A pedestal member 46 is disposed under the second rotary cutter 42a. The pedestal member 46 is larger (longer) than the width dimension W2 of the sheet-shaped member 12A whose opposite ends in the width direction have been cut by the first cutting unit 40. The pedestal member 46 is made of ceramic (made of zirconia, for example). With the sheet-shaped member 12A placed on the pedestal member 46, the second rotary cutter 42a is moved in the width direction of the sheet-shaped member 12A while being rotated in contact with the sheet-shaped member 12A, so that the sheet-shaped member 12 is cut to the product dimension.

The operation of the sheet material conveying device 10 constructed as explained above will be described below.

In FIGS. 1 and 2, the sheet-shaped member 12 is unwound from the roll body 14 while being separated from the interlayer film 22, and is conveyed by the suction member 16 toward the downstream side in the conveying direction while being guided by the intermediate guide roll 26. In parallel relation with the conveyance by the suction member 16, the sheet-shaped member 12 is cut by the cutting mechanism 20 in the longitudinal direction and the width direction, whereby the sheet-shaped member 12 is cut to the product dimension.

In this case, the sheet-shaped member 12 having been unwound from the roll body 14 is cut to the product width dimension in the first place by having the opposite end portions in the width direction cut by the first cutting unit 40 (the two first rotary cutters 40a) in the longitudinal direction. Incidentally, it is desirable that offcuts 12s (cut-off portions) hanging down be collected to a suitable place. Then, the sheet-shaped member 12A having been cut by the first cutting unit 40 to the product width dimension is conveyed by the suction member 16 toward the downstream side and is cut by the second cutting unit 42 (the second rotary cutter 42a) in the width direction of the sheet-shaped member 12A, whereby the sheet-shaped member 12A is cut to a square shape material having the product dimension of a predetermined length and a predetermine width.

In FIG. 3, the suction member 16 has arrived at the first position on the upstream side within an operating range and draws the lower surface 12a of the sheet-shaped member 12A at this position. Specifically, when the negative pressure generated by the negative pressure supply unit 18 (refer to FIG. 2) is supplied to the suction member 16, a suction force is generated on a suction surface 16a of the suction member 16. Thus, the suction member 16 draws the lower surface 12a of the sheet-shaped member 12 (sheet-shaped member 12A having been cut by the first cutting unit 40).

Then, the suction member 16 having drawn the sheet-shaped member 12 is moved in the conveying direction (the direction of the arrow X) under the driving action of the drive mechanism 30 (refer to FIG. 2), as shown in FIG. 4. Therefore, the sheet-shaped member 12 is conveyed in the conveying direction by the suction action and movement of the suction member 16.

During the conveyance of the sheet-shaped member 12, the two first rotary cutters 40a constituting the first cutting unit 40 cut the sheet-shaped member 12 in the longitudinal direction. The suction member 16 carries the sheet-shaped member 12 and arrives at the second position on the downstream side within the operating range. On the other hand, during the conveyance of the sheet-shaped member 12, the second rotary cutter 42a constituting the second cutting unit 42 is retracted from the sheet-shaped member 12 not to cut the sheet-shaped member 12.

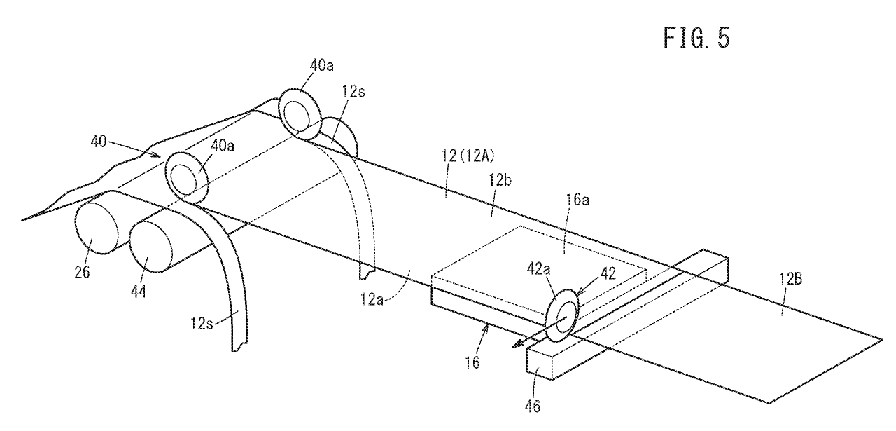

When the suction member 16 arrives at the aforementioned second position, as shown in FIG. 5, the second rotary cutter 42a is moved in the width direction of the sheet-shaped member 12A to cut the sheet-shaped member 12A in the width direction. Therefore, there is obtained a sheet-shaped member 12B having been cut to the predetermined product dimension. After the second rotary cutter 42a cuts the sheet-shaped member 12 in the width direction, the suction member 16 is moved toward the upstream side (the first cutting unit 40 side) under the action of the drive mechanism 30 (refer to FIG. 2) and is returned to the first position, as shown in FIG. 3. While being returned to the first position, the suction member 16 is moved under the condition that the negative pressure is stopped from being supplied to the suction member 16. Thus, the position of the sheet-shaped member 12A is kept unmoved.

By repeating the aforementioned operation which has been described with reference to FIG. 3 to FIG. 5, the sheet material conveying device 10 conveys and cuts the sheet-shaped member 12 having been unwound from the roll body 14 to produce the sheet-shaped members 12 cut out into the product dimension. Accordingly, the sheet material conveying device 10 performs the cutting operations of the sheet-shaped member 12 by the cutting mechanism 20 while intermittently conveying the sheet-shaped member 12 by the suction member 16.

In this case, the sheet material conveying device 10 according to the present embodiment is equipped with the suction member 16 constituted by the porous body that sucks under the negative pressure one surface of the sheet-shaped member 12 having been unwound from the roll and draws the sheet-shaped member 12 in the conveying direction, and the negative pressure supply unit 18 that supplies the negative pressure to the suction member 16. Therefore, unlike the conveyance by nip rolls, it is possible to convey the sheet-shaped member 12 while the sheet-shaped member 12 is prevented from being contacted and pressurized at the both surfaces. Accordingly, it is possible to reduce or suppress the possibility that contaminants are mixed with the sheet-shaped member 12.

In the present embodiment, the one surface of the sheet-shaped member 12 drawn by the suction member 16 is the lower surface 12a of the sheet-shaped member 12 facing downwards during conveyance. Accordingly, in the case where an upper surface 12b of the sheet-shaped member 12 facing upwards during conveyance becomes an electrode surface of a fuel cell, the electrode surface can suitably prevent contaminants from being mixed with. Therefore, the quality of fuel cell components can be improved.

In the present embodiment, the suction member 16 is made of ceramic. Thus, the sheet-shaped member 12 can suitably avoid metal contaminants from being mixed with.

In the present embodiment, at least one portion of the cutting mechanism 20 cuts the sheet-shaped member 12 while the sheet-shaped member 12 is being moved by the suction member 16. Therefore, it is possible to cut the sheet-shaped member 12 efficiently and to improve the productivity.

In the present embodiment, the cutting mechanism 20 has the first cutting unit 40 that cuts the sheet-shaped member 12 along the longitudinal direction of the sheet-shaped member 12 and the second cutting unit 42 that cuts the sheet-shaped member 12 along the width direction of the sheet-shaped member 12. Therefore, a process for cutting the sheet-shaped member 12 in the longitudinal direction and another process for cutting the sheet-shaped member 12 in the width direction can be carried out within the same equipment.

If the sheet-shaped member 12 is cut to the product dimension of a square shape using a die-cut blade (trim blade) unlike the present embodiment, needs a margin (remains of the sheet-shaped member 12 cut out as products) not only at opposite end portions in the width direction of the sheet-shaped member 12 but also between adjacent areas to be cut-out as products. In the present embodiment, on the contrary, because the sheet-shaped member 12 is cut by the first cutting unit 40 in the longitudinal direction and is cut by the second cutting unit 42 in the width direction, it becomes possible to perform the cutting operations of the products without the margin between the areas to be cut out as products.

In the present embodiment, the first cutting unit 40 is disposed on the upstream side in the conveying direction relative to the suction member 16, and the second cutting unit 42 is disposed on the downstream side in the conveying direction relative to the suction member 16. Therefore, by the movement of the suction member 16, it is possible to simultaneously carry out the conveying operation of the sheet-shaped member 12 and the unwinding operation of the sheet-shaped member 12 from the roll body 14.

In the present embodiment, the ceramic-made rotary cutters (the first rotary cutters 40a and the second rotary cutter 42a) cut the sheet-shaped member 12. Therefore, it is possible to eliminate a risk in which the cutting of the sheet-shaped member 12 accompanies metal contaminants mixed with the sheet-shaped member 12.

The present invention is not limited to the foregoing embodiment, and various modifications of the present invention are possible within a scope that does not deviate from the gist of the present invention.

What is claimed is:

1. A sheet material conveying device for unwinding and conveying a sheet-shaped member constituting a membrane electrode assembly, from a roll body which is configured by the sheet-shaped member wound in a form of a roll, the conveying device comprising:
a suction member configured by a porous body to draw under a negative pressure one surface of the sheet-shaped member having been unwound from the roll body and to move the sheet-shaped member in a conveying direction; and
a negative pressure supply unit configured to supply the negative pressure to the suction member.

2. The sheet material conveying device according to claim 1, wherein the one surface of the sheet-shaped member drawn by the suction member is a lower surface of the sheet-shaped member that faces downwards during conveyance.

3. The sheet material conveying device according to claim 1, wherein the suction member is made of ceramic.

4. The sheet material conveying device according to claim 1, wherein the suction member is configured to be reciprocatively movable between a first position on an upstream side and a second position on a downstream side set along the conveying direction and to move the sheet-shaped member by a predetermined length at a time in the conveying direction.

5. The sheet material conveying device according to claim 1, further comprising:
a cutting mechanism configured to cut the sheet-shaped member having been unwound from the roll body;
wherein at least one portion of the cutting mechanism is configured to cut the sheet-shaped member while the sheet-shaped member is being moved by the suction member.

6. The sheet material conveying device according to claim 5, wherein:
the sheet-shaped member is belt-shaped; and
the cutting mechanism includes a first cutting unit constituting the at least one portion and configured to cut the sheet-shaped member along a longitudinal direction of the sheet-shaped member and a second cutting unit configured to cut the sheet-shaped member along a width direction of the sheet-shaped member.

7. The sheet material conveying device according to claim 6, wherein:
the first cutting unit is disposed on an upstream side in the conveying direction relative to the suction member; and
the second cutting unit is disposed on a downstream side in the conveying direction relative to the suction member.

8. The sheet material conveying device according to claim 7, wherein the second cutting unit is configured to refrain from cutting the sheet-shaped member while the first cutting unit is cutting the sheet-shaped member.

9. The sheet material conveying device according to claim 5, wherein the cutting mechanism has a rotary cutter made of ceramic.

10. The sheet material conveying device according to claim 6, wherein:
the first cutting unit has a first rotary cutter; and
the second cutting unit has a second rotary cutter movable in the width direction of the sheet-shaped member.

11. The sheet material conveying device according to claim 7, wherein the first cutting unit is configured to refrain from cutting the sheet-shaped member while the second cutting unit is cutting the sheet-shaped member.

12. The sheet material conveying device according to claim 6, wherein the sheet-shaped member having been unwound from the roll body has opposite end portions in the width direction, and
the first cutting unit is configured to cut the opposite end portions in the longitudinal direction so that the sheet-shaped member has a product width dimension before being cut by the second cutting unit along the width direction.

13. The sheet material conveying device according to claim 12, wherein the suction member is configured to convey the sheet-shaped member having been cut into the product width dimension by the first cutting unit toward a downstream side, and
the second cutting unit is configured to cut the conveyed sheet-shaped member along the width direction into a square shape material of a product dimension which has a predetermined length and a predetermined width.

14. The sheet material conveying device according to claim 6, wherein:
the first cutting unit is configured to cut the sheet-shaped member in the longitudinal direction during conveyance of the sheet-shaped member; and
the second cutting unit is configured to be retracted from the sheet-shaped member not to cut the sheet-shaped member while the sheet-shaped member is being conveyed.

15. The sheet material conveying device according to claim 6, wherein the suction member is configured to convey the sheet-shaped member while moving from a first position on an upstream side within a movable range of the suction member to a second position on a downstream side within the movable range, and to move without drawing the sheet-shaped member while returning from the second position to the first position.

16. The sheet material conveying device according to claim 5, wherein the sheet-material conveying device is configured to cut the sheet-shaped member by the cutting mechanism while intermittently conveying the sheet-shaped member by the suction member.
